(19) United States
(12) Patent Application Publication
(10) Pub. No.: US 2026/0326003 A1
(43) Pub. Date: Oct. 22, 2026

(54) SYSTEM AND METHODS FOR WASHING REUSABLE AIR FILTERS

(71) Applicant: K&N Engineering, Inc., Corona, CA (US)

(72) Inventors: Steve Williams, Cherry Valley, CA (US); Humberto Marre, Corona, CA (US); Noah Cuevas, Corona, CA (US); Branden Kim, Corona, CA (US); Joost Adriaans, Corona, CA (US)

(73) Assignee: K&N Engineering, Inc., Corona, CA (US)

(21) Appl. No.: 19/727,464

(22) Filed: Jul. 1, 2026

Related U.S. Application Data
(63) Continuation-in-part of application No. 19/036,470, filed on Jan. 24, 2025.
(60) Provisional application No. 63/627,684, filed on Jan. 31, 2024.

(51) Int. Cl. B01D 41/04; B08B 3/02; B08B 3/04; B08B 3/08; B08B 3/12; B08B 13/00; F26B 20/00; F26B 21/00

(52) U.S. Cl. CPC B01D 41/04; B08B 3/022; B08B 3/041; B08B 3/08; B08B 3/123; B08B 13/00; F26B 20/00; F26B 21/001

(57) ABSTRACT

A filter washing system and methods are provided for cleaning and drying reusable air filters. The filter washing system comprises a conveyor that transits dirty air filters through a series of stations for wetting, agitating, rinsing, and drying the air filters. A pre-wetting station sprays dirty air filters with water and applies a cleaning solution. The cleaning solution is given time to soak into the filter material of the air filters. The air filters are then submerged and in an ultrasonic cleaning station. Ultrasonic vibrations are applied to the submerged air filters to loosen contaminants and debris that may be entrapped in the dirty air filters. A rinsing station uses water to flush loosened contaminants, debris, and the cleaning solution from the air filters exiting the ultrasonic cleaning station. Blowers and agitators are used to dry the cleaned air filters exiting the rinsing station.

### PRIORITY

This application is a continuation-in-part of, and claims the benefit of, U.S. patent application, entitled “System And Methods For A Filter Washing Station,” filed on Jan. 24, 2025, and having application Ser. No. 19/036,470, which claims the benefit of, and priority to, U.S. Provisional Application, entitled “System And Methods For A Filter Washing Station,” filed on Jan. 31, 2024, and having application Ser. No. 63/627,684, the entirety of both of said applications being incorporated herein by reference.

### FIELD

Embodiments of the present disclosure generally relate to filtration devices. More specifically, embodiments of the disclosure relate to a system and methods for washing and drying reusable air filters.

### BACKGROUND

An air filter designed to remove particulate is generally a device composed of fibrous materials. These fibrous materials may remove solid particulates such as dust, pollen, mold, and bacteria from the air. Air filters are used in applications where air quality is important, notably in building ventilation systems and in automobile engines.

Air filters may be used in automobiles, trucks, tractors, locomotives and other vehicles that use internal combustion engines. Air filters may be used with gasoline engines, diesel engines, or other engines that run on fossil fuels or other combustible substances. Air filters may be used with engines in which combustion is intermittent, such as four-stroke and two-stroke piston engines, as well as other types of engines that take in air so as to burn a combustible substance. For example, air filters may be used with some gas turbines. Filters may also be used with air compressors or in other devices that take in air.

Filters may be made from pleated paper, foam, cotton, spun fiberglass, or other known filter materials. Generally, the air intakes of internal combustion engines and compressors tend to use paper, foam, or cotton filters. Some filters use an oil bath. Air filters for internal combustion engines prevent abrasive particulate matter from entering the engine's cylinders, where it would cause mechanical wear and oil contamination.

A drawback to paper air filters is that they must be thick, or the fibers must be tightly compressed and dense, which makes paper filters restrictive to air flow. Moreover, as a paper filter becomes more and more clogged with contaminants, the pressure inside the filter drops while the atmospheric air pressure outside the filter remains the same. When the pressure differential becomes too great, due to clogging, contaminants may be pulled through the restricted air filter into the engine. Thus, the performance of a paper air filter (i.e. air flow through the filter and its ability to protect the engine) decreases over the course of the filter's service life. Typically, a dirty paper air filter is removed from the vehicle and discarded, and a new paper air filter is then installed.

Considering that there are millions of vehicles throughout the world, the volume of discarded air filters that could be eliminated from landfills is a staggering number. In an attempt to reduce the number of discarded filters, some filters are configured to be periodically cleaned rather than replaced. In some instances, an air filter may be cleaned by removing the air filter from a vehicle, inserting a water hose into an interior cavity of the filter, and then spraying water to flush contaminants from the filter material. The cleaned air filter is then left to dry before being reinstalled into the vehicle.

A drawback to cleaning reusable air filters is that the cleaning process can be time consuming. In cases where a multiplicity of vehicles are operated and maintained, the time requirement for cleaning numerous air filters tends to encourage replacing conventional filters instead of reusing cleanable filters. Given the number of air filters in use, there is a continuing desire to make cleaning and reusing filters easy, cost effective, and less time consuming.

### SUMMARY

A filter washing system and methods are provided for cleaning and drying reusable air filters. The filter washing system comprises a conveyor that transits dirty air filters through a series of stations for wetting, agitating, rinsing, and drying the air filters. A pre-wetting station sprays dirty air filters with water and applies a cleaning solution. The cleaning solution is given time to soak into the filter material of the air filters. The air filters are then submerged and in an ultrasonic cleaning station. Ultrasonic vibrations are applied to the submerged air filters to loosen contaminants and debris that may be entrapped in the dirty air filters. A rinsing station uses water to flush loosened contaminants, debris, and the cleaning solution from the air filters exiting the ultrasonic cleaning station. Blowers and agitators are used to dry the cleaned air filters exiting the rinsing station.

In an exemplary embodiment, a system for cleaning and drying reusable air filters comprises: an exterior housing having an entrance for receiving one or more air filters; a conveyor for moving the one or more air filters through the exterior housing; a series of stations disposed along the conveyor for cleaning and drying the one or more air filters; and an exit of the exterior housing for discharging the one or more air filters.

In another exemplary embodiment, the series of stations comprises any one or more of a pre-wetting station, an ultrasonic cleaning station, a rinsing station, and a drying station. In another exemplary embodiment, the pre-wetting station is configured to wet the one or more air filters. In another exemplary embodiment, the pre-wetting station is configured to apply a suitable cleaning solution to the one or more air filters. In another exemplary embodiment, the pre-wetting station is configured to wet both sides of each of the one or more air filters. In another exemplary embodiment, the pre-wetting station is configured to apply the cleaning solution to a dirty side of each of the one or more air filters.

In another exemplary embodiment, the ultrasonic cleaning station is configured to submerge each of the one or more air filters in a suitable cleaning solution. In another exemplary embodiment, the ultrasonic cleaning station is configured to apply ultrasonic vibrations to each of the one or more air filters to loosen contaminants and debris that may be entrapped in the one or more air filters.

In another exemplary embodiment, the ultrasonic vibrations range in frequency between about 25 kHz and about 170 kHz. In another exemplary embodiment, the ultrasonic vibrations range in frequency may range between about 70 kHz and about 130 kHz. In another exemplary embodiment, the ultrasonic vibrations range in frequency between about 35 kHz and about 68 kHz. In another exemplary embodiment, the ultrasonic vibrations have a frequency of about 40 kHz.

In another exemplary embodiment, the rinsing station is configured to use cleaning water to flush contaminants, debris, and the cleaning solution from each of the one or more air filters exiting the ultrasonic cleaning station. In another exemplary embodiment, the rinsing station includes a piping system that includes water nozzles configured to spray water onto the one or more air filters.

In another exemplary embodiment, the drying station is configured to dry the one or more air filters exiting the rinsing station. In another exemplary embodiment, the drying station includes one or more blowers configured to direct an airstream onto each of the one or more air filters. In another exemplary embodiment, the drying station is configured to spin each of the one or more air filters to throw off water the one or more air filters. In another exemplary embodiment, the drying station is configured to agitate each of the one or more air filters to throw off water the one or more air filters.

In an exemplary embodiment, a method for forming a system for cleaning and drying reusable air filters comprises: forming an exterior housing having an entrance for receiving one or more air filters; configuring a conveyor for moving the one or more air filters through the exterior housing; arranging a series of stations along the conveyor for cleaning and drying the one or more air filters; and forming an exit of the exterior housing for discharging the one or more air filters.

In another exemplary embodiment, arranging the series of stations comprises including any one or more of a pre-wetting station, an ultrasonic cleaning station, a rinsing station, and a drying station.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 is a diagram illustrating an exemplary embodiment of a filter washing system for cleaning and drying reusable air filters, according to the present disclosure;

FIG. 2 is a flow chart illustrating an exemplary embodiment of a water cycle that may be incorporated into a filter washing station, according to the present disclosure;

FIG. 3 illustrates an exemplary embodiment of a process for cleaning and drying reusable air filters in accordance with the present disclosure; and

FIG. 4 provides an exemplary block illustration of a data processing system that may be used in conjunction with a filter washing system in accordance with various embodiments of the present disclosure.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the filter washing system and methods disclosed herein may be practiced without these specific details. In other instances, specific numeric references such as “first nozzle,” may be made. However, the specific numeric reference should not be interpreted as a literal sequential order but rather interpreted that the “first nozzle” is different than a “second nozzle.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

As there are millions of vehicles throughout the world, the volume of discarded air filters that could be eliminated from landfills is a staggering number. In an attempt to reduce the number of discarded filters, some filters are configured to be periodically cleaned and reused rather than replaced. A drawback to cleaning reusable air filters, however, is that the cleaning process can be time consuming. In cases where a multiplicity of vehicles are operated and maintained, the time requirement for cleaning numerous air filters tends to encourage replacing conventional filters instead of reusing cleanable filters. Embodiments presented herein provide a filter washing system that is configured to make cleaning and drying reusable air filters easy, cost effective, and less time consuming.

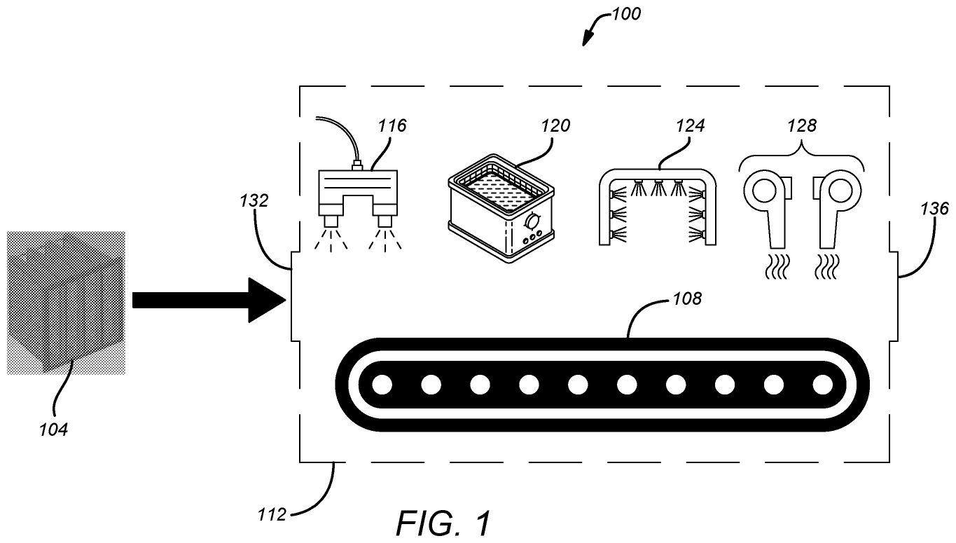

FIG. 1 illustrates an exemplary embodiment of a filter washing system 100 for cleaning and drying reusable air filters 104, according to the present disclosure. The filter washing system 100 comprises a conveyor 108 configured to transit one or more air filters 104 through a series of stations contained within an exterior housing 112. In the illustrated embodiments, the stations include a pre-wetting station 116, an ultrasonic cleaning station 120, a rinsing station 124, and a drying station 128. As such, dirty air filters 104 can be placed into an entrance 132 of the housing 112, and the air filters 104 can be retrieved from an exit 136 of the housing 112 after having been cleaned and dried. Air filters 104 that are retrieved from the filter washing system 100 are ready to be put back into service.

As shown in FIG. 1, the conveyor 108 moves a newly introduced dirty air filter 104 to the pre-wetting station 116. The pre-wetting station 116 is configured to wet the dirty air filter 104 and/or apply a suitable cleaning solution to the air filter 104. In some embodiments, the pre-wetting station 116 is configured to wet both sides of the dirty air filter 104 but apply cleaning solution only to the dirty side of the air filter 104. The pre-wetting station 116 is configured to prepare the air filter 104 for being washed by loosening contaminants and debris that may be entrapped in the air filter 104. In some embodiments, the cleaning solution can include a solvent capable of cleaning oil that may have been applied to the air filter 104 to enhance its filtration efficiency. In some embodiments, the air filter 104 may be allowed to soak for a period of time before the conveyor 108 moves the air filter out of the pre-wetting station 116.

Next, the dirty air filter 104 is moved to the ultrasonic cleaning station 120. While in the ultrasonic cleaning station 120, the dirty air filter 104 may be immersed in a suitable cleaning solution and then subjected to ultrasonic vibrations that are capable of loosening contaminants and debris that may be entrapped in the air filter 104. It is contemplated that the conveyor 108 is configured to move the air filter 104 into and out of a tank large enough to submerge the entire air filter 104 in cleaning solution. The ultrasonic vibrations may operate at any frequency that is found to produce the cleanest results. Broadly speaking, however, the ultrasonic vibrations may range in frequency between about 25 kHz and about 170 kHz, without limitation. In some embodiments, the frequency may range between about 35 kHz and about 68 kHz, and in particular, the frequency may be about 40 kHz. In other embodiments, however, the frequency may range between about 70 kHz and about 130 kHz or more, as needed, without limitation.

Once the ultrasonic cleaning has finished, the conveyor 108 moved the cleaned air filter 104 to the rinsing station 124. The rinsing station 124 is configured to use cleaning water to flush any remaining contaminants and debris as well as the cleaning solution from the air filter 104. In some embodiments rinsing station 124 is configured to circulate the cleaning water at about 10 GPM (gallons per minute) at a water pressure ranging between about 60 PSI and about 100 PSI, without limitation. It is contemplated that the filter washing system 100 is configured to enable the water pressure to be adjusted, as desired.

It is contemplated that the filter washing system 100 may include a water tank that stores a volume of cleaning water that is cycled within the rinsing station 124 for flushing the cleaning solution and loosened contaminants from the air filter 104. In an embodiment, the volume of cleaning water is about 23.74 gallons. In an embodiment, the water tank comprises a 27-gallon tank. In some embodiments, the water tank may include a wire mesh configured to filter the cleaning water as it flows from the rinsing station 124 to the water tank. In an embodiment, the wire mesh 114 comprises 304 stainless-steel with an opening size of about 0.032 inches to capture macroscopic particles flowing with the cleaning water.

In some embodiments, the housing 112 supports components that circulate the cleaning water within the filter washing system 100, as described herein. For example, the housing 112 may support a water pump, a permeate tank, and one or more filter cartridges. In some embodiments, the water pump may comprise a 115V 10-stage booster pump while the filter cartridges may comprise one or more 50-micron filters configured to operate at a flowrate of about 10 GPM and a pressure of about 125 PSI. In some embodiments, the water pump may receive cleaning water from the water tank by way of pipes that include a 90-micron sediment filter to remove particles that may have passed through the mentioned-above wire mesh. Cleaning water exiting the water pump may be then directed to the filter cartridges before being passed into the permeate tank.

In some embodiments, the filter washing system 100 may include a secondary water pump configured to pump cleaning water from the above-mentioned permeate tank to the air filters 104 being cleaned inside the rinsing station 124. The secondary water pump may draw cleaning water from the permeate tank and push the cleaning water to the air filters 104 by way of a piping system that includes water nozzles configured to spray water onto the air filters 104 so as to flush cleaning solution and loosened contaminants from the air filter 104. The water and contaminants may be passed to the bottom of the rinsing station 124 wherein the contaminants are strained by the above-mentioned wire mesh, while the water passes through the wire mesh before being filtered and recirculated through the filter washing system 100 as described above.

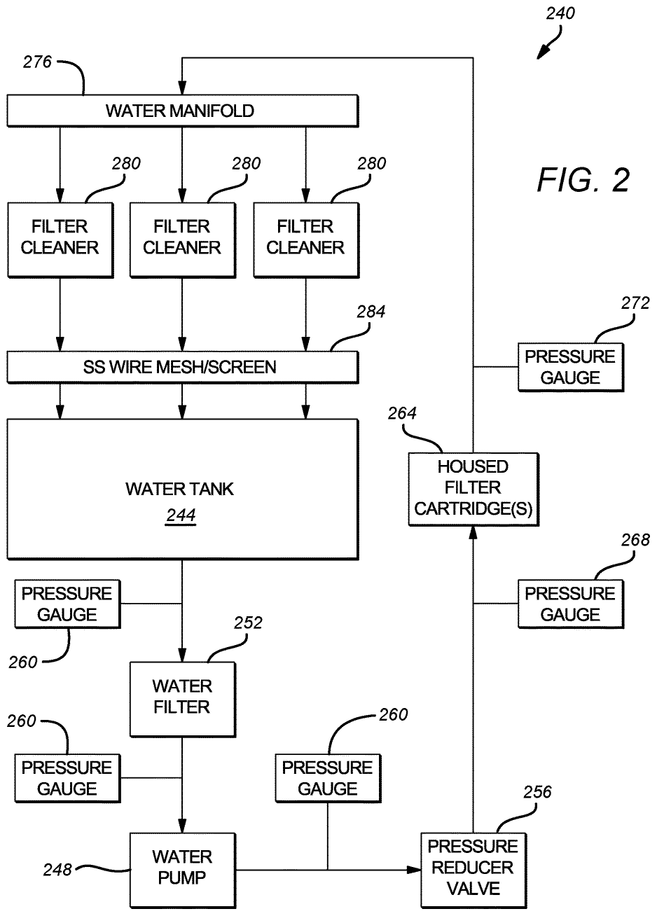

FIG. 2 illustrates an exemplary embodiment of a water cycle 240 that may be incorporated into the filter washing system 100, according to the present disclosure. The water cycle 240 generally begins with a water tank 244 and a water pump 248. The water tank 244 provides a reservoir that stores a volume of cleaning water that is cycled within the filter washing system 100, such as within the rinsing station 124 shown in FIG. 1, for flushing cleaning solution, applied by the pre-wetting station 116, and contaminants loosened by the ultrasonic cleaning station 120 from the air filters 104. As shown in FIG. 2, the water pump 248 draws cleaning water from the water tank 244 through a water filter 252. The water pump 248 may comprise a 115V 10-stage booster pump while the water filter 252 may comprise a 90-micron sediment filter that is configured to remove macroparticles that may be flowing with the cleaning water.

In the water cycle 240 shown in FIG. 2, cleaning water exiting the water pump 248 passes to a pressure reducing valve 256. The pressure reducing valve 256 is configured to control the pressure of the water being sprayed onto one or more air filters 104 to be cleaned. In some embodiments, the pressure reducing valve 256 has a maximum pressure of about 150 PSI. Further, multiple pressure gauges 260 are coupled with the water cycle 240 and configured to report the water pressure at locations between the water tank 244 and the water filter 252, between the water filter 252 and the water pump 248, as well as between the water pump 248 and the pressure reducer valve 256.

Next, cleaning water exiting the pressure reducer valve 256 is pumped to housed filter cartridges 264. In some embodiments, the housed filter cartridges 264 comprise one or more 50-micron filters configured to operate at a flowrate of about 10 GPM and at a pressure of about 125 PSI. In some embodiments, the housed filter cartridges 264 are washable disk elements. In some embodiments, the washable disk elements are 5-inch polyester elements that are rated for a flowrate of about 10 GPM at a pressure of about 60 PSI, as described hereinabove. Further, an upstream pressure gauge 268 and a downstream pressure gauge 272 are configured to facilitate observing the change in water pressure across the housed filter cartridges 264.

With continuing reference to FIG. 2, cleaning water exiting the housed filter cartridges 264 and the pressure gauges 268, 272 is pumped to a water manifold 276. The water manifold 276 distributes the cleaning water among multiple filter cleaners 280 that are each dedicated to flushing contaminants from a single filter, such as the air filter 104. The filter cleaners 280 may each provide a dedicated cleaning pipe and a water nozzle for each filter to be cleaned. The dedicated cleaning pipes may include water nozzles that are configured to spray cleaning water onto the air filters 104 so as to rinse cleaning fluid and flush contaminants from the air filters 104. In some embodiments, the water nozzles may direct a full cone spray pattern at 120-degrees onto each filter. It is contemplated that the full cone spray pattern can have a 30-inch diameter at a flowrate between about 3-4 GPM and a water pressure of about 60 PSI. Next, the water and contaminants draining from the filters 120 passes to a stainless-steel wire mesh 284 that strains the contaminants allowing the water to drain into the tank 244 before being filtered and recirculated through the water cycle 240.

Turning, again, to FIG. 1, once the air filter 104 has been sufficiently rinsed free of cleaning solution and contaminants, the conveyor 108 moves the air filter 104 to the drying station 128. As will be appreciated, the drying station 128 is configured to dry air filters after the cleaning process is completed. The drying station 128 can include one or more blowers configured to direct an airstream onto the air filters 104 to dry the air filter 104. In some embodiments, a DC motor may be coupled with each air filter 104 and configured to spin the filters during the drying process. Centrifugal forces during spinning the air filters 104 will throw water off the air filters 104 while air turbulence provides enhanced drying of the air filters 104. In some embodiments, the air filters 104 may be agitated, such as being shaken back and forth, to throw water off the air filters 104 while introducing air turbulence for shortening drying times. In some embodiments, the air filters 104 may be shaken along a vertical axis to throw water off the air filters 104 while introducing air turbulence, as described. Thus, in some embodiments, the DC motors may be configured to subject the air filters 104 to any one or more of spinning, shaking vertically, shaking horizontally, or any combination thereof.

Moreover, it should be borne in mind that that the filter washing system 100 is not limited to cleaning and drying only V-bank filters air filters 104, as shown in FIG. 1. Rather, the filter washing system 100 may be configured to clean and dry any type and configuration of filter having exposed filter material that is amenable to being sprayed with a cleaning fluid, without limitation. For example, the filter washing system 100 may be configured to clean and dry panel-shaped HVAC filters having various sizes and shapes, without limitation. Further, in some embodiments, the filter washing system 100 may be configured to flush and dry any of various partially enclosed air filters having an exterior cross-sectional shape that may be generally circular, oval, or otherwise shaped so as to provide a relatively large surface area in a given volume of the air filter, without limitation.

It is contemplated that the filter washing system 100 may be configured to operate with a cleaning fluid other than water-soluble cleaners, without limitation. For example, in some embodiments, the filter washing system 100 may utilize a cleaning solvent for cleaning filters that are treated with a filter oil composition that causes tackiness throughout the air filter medium. In such embodiments, the cleaning solvent may be sprayed onto the filters by the pre-wetting station 116 to break up the filter oil composition and flush away any contaminants entrapped in the filter media. In some embodiments, the filter washing system 100 may be configured to provide a combination cleaning cycle wherein the cleaning solvent is used to remove the filter oil composition and then water is used to flush contaminants from the filters, as described herein. Further, it is contemplated that in some embodiments, the filter washing system 100 may be configured to clean and dry the filters, as described above, and then apply a new coat of filter oil composition to the filter media, without limitation.

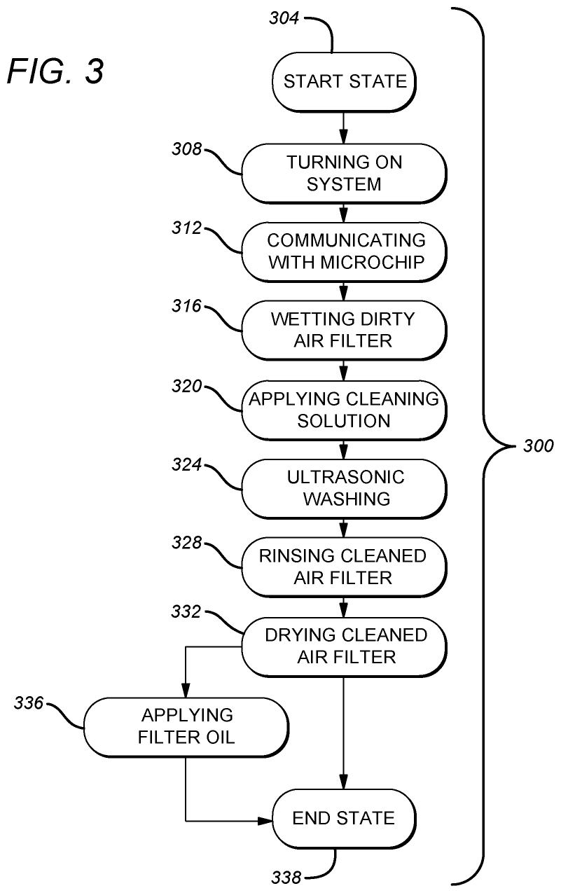

FIG. 3 illustrates an exemplary embodiment of a process 300 for cleaning and drying reusable air filters in accordance with the present disclosure. The process 300 begins with a start state 304 that may include loading one or more reusable air filters (e.g., the air filter 104 of FIG. 1) into a filter washing system, such as the filter washing system 100 of FIG. 1. The start state 304 may further include supplying electric power to the filter washing system 100.

Next, the process 300 moves to step 308 comprising turning on the filter washing system 100. In some embodiments, step 308 includes using suitable circuitry to turn on one or more pumps for supplying water and cleaning solution to the pre-wetting station 116, the ultrasonic cleaning station 120, and the rinsing station 124. For example, in some embodiments, step 308 can include using suitable circuitry to turn on a water pump 248 (see FIG. 2) for cycling rinsing water in the rinsing station 124, as described above. In some embodiments, step 308 includes supplying electric power to one or more microchips or microcontrollers comprising the circuitry of the filter washing system 100.
Step 312 comprises communicating with the one or more microchips or microcontrollers to cause the filter washing system 100 to clean the air filter 104. In some embodiments, such communications can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals-such as carrier waves, infrared signals, digital signals).
Step 316 comprises the filter washing system 100 using the conveyor 108 to move a newly introduced dirty air filter 104 to the pre-wetting station 116. In step 316, water is spray onto the dirty air filter 104 to prepare the filter material for cleaning. In step 320, a suitable cleaning solution is then sprayed onto the pre-wetted air filter 104. In some embodiments, the pre-wetting station 116 sprays water on both sides of the dirty air filter 104 but applies cleaning solution only to the dirty side of the air filter 104. The pre-wetting station 116 is configured to prepare the filter material for cleaning by loosening contaminants and debris that may be entrapped in the air filter 104.

In some embodiments, the abovementioned circuitry may be configured to operate each of the one or more pumps of the pre-wetting station 116 for between about 90-seconds and about 120-seconds before turning off each pump. In some embodiments, the length of time is controlled by the communications with the one or more microcontrollers, performed in step 312. As will be appreciated, the length of time to run the pumps generally comprises an amount of time required to advantageously pre-wet and apply a sufficient quantity of cleaning solution to the air filter 104.

In some embodiments, step 320 may further comprise applying a cleaning solution that includes a solvent capable of cleaning oil that may have been applied to the air filter 104 to enhance its filtration efficiency. In some embodiments, the air filter 104 may be allowed to soak in the cleaning solution and solvent for a period of time before the conveyor 108 moves the air filter 104 out of the pre-wetting station 116. In some embodiments, the length of time the air filter 104 is allowed to soak is controlled by the communications with the one or more microcontrollers, performed in step 312. In general, the length of time to soak the filter with cleaning solution and solvent generally comprises an amount of time required to loosen contaminants, debris, and filter oil that may be present on the air filter 104.

In step 324, the conveyor 108 moves the soaked air filter 104 to the ultrasonic cleaning station 120. While in the ultrasonic cleaning station 120, the air filter 104 may be immersed in a suitable cleaning solution and then subjected to ultrasonic vibrations that are capable of loosening contaminants, debris, and filter oil that may be present in the filter material comprising the air filter 104. As will be appreciated, the conveyor 108 is configured to move the air filter 104 into and out of a tank large enough to submerge the entire air filter 104 in cleaning solution. The ultrasonic vibrations may operate at any frequency that is found to produce the cleanest results. In some embodiments, the ultrasonic vibrations may range in frequency between about 25 kHz and about 170 kHz, without limitation. In some embodiments, the frequency may range between about 35 kHz and about 68 kHz, and in particular, the frequency may be about 40 kHz. In other embodiments, however, the frequency may range between about 70 kHz and about 130 kHz or more, as needed, without limitation.

In some embodiments, the air filter 104 may be subjected to ultrasonic vibrations for a period of time before the conveyor 108 moves the air filter 104 out of the ultrasonic cleaning station 120. In some embodiments, the length of time the air filter 104 is subjected to ultrasonic vibrations is controlled by the communications with the one or more microcontrollers, performed in step 312. In general, the length of time to subject the air filter 104 to ultrasonic vibrations comprises an amount of time required to loosen contaminants, debris, and filter oil that may be present on the air filter 104. Further, the operating frequency of the ultrasonic vibrations may be controlled by the communications with the one or more microcontrollers, performed in step 312. In some embodiments, however, the circuitry enables a practitioner to select the operating frequency of the ultrasonic vibrations as well as a length of time to run the ultrasonic cleaning station 120.

Next, in step 328, the conveyor 108 moves the air filter 104 to the rinsing station 124, shown in FIG. 1. The rinsing station 124 is configured to use cleaning water to flush any remaining contaminants and debris as well as the cleaning solution from the air filter 104. In some embodiments rinsing station 124 circulates the cleaning water at about 10 GPM (gallons per minute) at a water pressure ranging between about 60 PSI and about 100 PSI, without limitation. It is contemplated that the filter washing system 100 is configured to enable the water pressure to be adjusted, as desired.

It is contemplated that the filter washing system 100 may include a water tank 244 (see FIG. 2) that stores a volume of cleaning water that is cycled within the rinsing station 124 for flushing the cleaning solution and loosened contaminants from the air filter 104. As described above with respect to FIG. 2, the water cycle 240 generally begins with the water tank 244 and a water pump 248. In some embodiments, the abovementioned circuitry may be configured to operate the pump 248 for between about 90-seconds and about 120-seconds before turning off the pump. In some embodiments, the circuitry enables a practitioner to select a length of time to run the water pump 248. In some embodiments, the length of time is controlled by the communications with the one or more microcontrollers, performed in step 312. As will be appreciated, the length of time to run the water pump 248 generally comprises an amount of time required to advantageously flush contaminants and the cleaning solution from the air filter 104.

Once the length of time to run the water pump 248 has elapsed, the water pump 248 is turned off and the process 300 advances to step 332. It is contemplated that turning off the water pump 248 occurs after contaminants have been flushed from the filters 120. In some embodiments, one or more sensors may be used to detect the quantity of contaminants flowing with the water. As such, in some embodiments, the length of time to run the water pump 248 before turning off the pump may be determined based on the quantity of contaminants flowing with the water. In such embodiments, the air filter 104 can be considered “clean” once the quantity of contaminants flowing with the water decreases below a threshold value.

Once the air filter 104 has been advantageously flushed free of contaminants, the process 300 moves to step 332, wherein the conveyor 108 moves the air filter 104 to the drying station 128. The drying station 128 is configured to subject the air filter 104 to a drying process. The drying station 128 can include one or more blowers configured to direct an airstream onto the air filter 104 to dry the filter material comprising the air filter 104. As described with respect to FIGS. 1-2, a DC motor may be coupled with the air filter 104 and configured to spin the air filter 104 during the drying process. It is contemplated that centrifugal forces during spinning the air filter 104 throws excess water off the air filter 104 while air turbulence provides enhanced drying of the air filter 104. In some embodiments, the air filter 104 may be agitated, such as being shaken horizontally, to throw excess water off the air filter 104 while introducing air turbulence to shorten the drying time. In some embodiments, the air filter 104 may be shaken vertically to throw excess water off the air filter 104 while introducing air turbulence, as described. It is contemplated that the air filter 104 may be subjected to any path that is found to effectively throw water off the air filter 104, without limitation.

In some embodiments, the process 300 may be used to clean and service reusable air filters 104 that include a filter oil composition that causes tackiness throughout a filter media of the air filters 104. It is contemplated that a practitioner may specify a filter type (e.g., “oiled” or “non-oiled”) in steps 312-316. When air filters 104 of the oiled variety are cleaned and dried in step 332, a filter oil composition may be applied to the air filters 104 in step 336. In some embodiments, the filter washing system 100 may include a dedicated pipe and spray nozzle configured to spray the filter oil composition onto the air filters 104.

Once the air filters 104 have been advantageously treated with the filter oil composition, the process 300 moves to an end state 338, wherein the air filters 104 may be removed from the filter washing system 100 and returned to service. When the air filters 104 are of the non-oiled variety, the process 300 skips step 336 and moves directly from step 332 to the end state 338. In some embodiments, the filter washing system 100 may be configured to indicate to a practitioner when the air filters 104 are ready to be removed from the filter washing system 100. For example, in some embodiments, a light may illuminate and/or an audible alarm may sound when the air filters 104 are ready to be removed from the filter washing system 100.

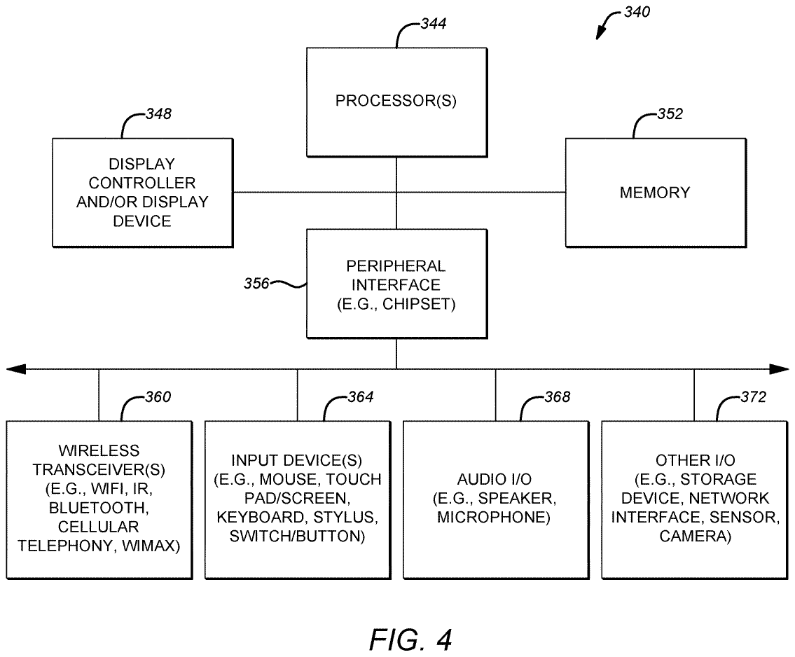

Turning, now, to FIG. 4, a block diagram illustrates an exemplary data processing system 340 that may be used in conjunction with the filter washing system 100 to perform any of the processes or methods described herein. Data processing system 340 may represent circuitry within a desktop, a tablet, a server, a mobile phone, a personal digital assistant (PDA), a personal communicator, a network router or hub, a wireless access point (AP) or repeater, a set-top box, or any combination thereof.

In an embodiment, illustrated in FIG. 4, system 340 includes a processor 344 and a peripheral interface 356, also referred to herein as a chipset, to couple various components to the processor 344, including a memory 352 and devices 360-372 via a bus or an interconnect. Processor 344 may represent a single processor or multiple processors with a single processor core or multiple processor cores included therein. Processor 344 may represent one or more general-purpose processors such as a microprocessor, a central processing unit (CPU), or the like. More particularly, processor 344 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 344 may also be one or more special-purpose processors such as an application specific integrated circuit (ASIC), a field programmable gate array (FPGA), a digital signal processor (DSP), a network processor, a graphics processor, a network processor, a communications processor, a cryptographic processor, a co-processor, an embedded processor, or any other type of logic capable of processing instructions. Processor 344 is configured to execute instructions for performing the operations and steps discussed herein.

Peripheral interface 356 may include a memory control hub (MCH) and an input output control hub (ICH). Peripheral interface 356 may include a memory controller (not shown) that communicates with a memory 352. The peripheral interface 356 may also include a graphics interface that communicates with graphics subsystem 348, which may include a display controller and/or a display device. The peripheral interface 356 may communicate with the graphics device 348 by way of an accelerated graphics port (AGP), a peripheral component interconnect (PCI) express bus, or any other type of interconnect.

An MCH is sometimes referred to as a Northbridge, and an ICH is sometimes referred to as a Southbridge. As used herein, the terms MCH, ICH, Northbridge and Southbridge are intended to be interpreted broadly to cover various chips that perform functions including passing interrupt signals toward a processor. In some embodiments, the MCH may be integrated with the processor 344. In such a configuration, the peripheral interface 356 operates as an interface chip performing some functions of the MCH and ICH. Furthermore, a graphics accelerator may be integrated within the MCH or the processor 344.

Memory 352 may include one or more volatile storage (or memory) devices, such as random access memory (RAM), dynamic RAM (DRAM), synchronous DRAM (SDRAM), static RAM (SRAM), or other types of storage devices. Memory 352 may store information including sequences of instructions that are executed by the processor 344, or any other device. For example, executable code and/or data of a variety of operating systems, device drivers, firmware (e.g., input output basic system or BIOS), and/or applications can be loaded in memory 352 and executed by the processor 344. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

Peripheral interface 356 may provide an interface to IO devices, such as the devices 360-372, including wireless transceiver(s) 360, input device(s) 364, audio IO device(s) 368, and other IO devices 372. Wireless transceiver 360 may be a WiFi transceiver, an infrared transceiver, a Bluetooth transceiver, a WiMax transceiver, a wireless cellular telephony transceiver, a satellite transceiver (e.g., a global positioning system (GPS) transceiver) or a combination thereof. Input device(s) 364 may include a mouse, a touch pad, a touch sensitive screen (which may be integrated with display device 348), a pointer device such as a stylus, and/or a keyboard (e.g., physical keyboard or a virtual keyboard displayed as part of a touch sensitive screen). For example, the input device 364 may include a touch screen controller coupled with a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

Audio IO 368 may include a speaker and/or a microphone to facilitate voice-enabled functions, such as voice recognition, voice replication, digital recording, and/or telephony functions. Other optional devices 372 may include a storage device (e.g., a hard drive, a flash memory device), universal serial bus (USB) port(s), parallel port(s), serial port(s), a printer, a network interface, a bus bridge (e.g., a PCI-PCI bridge), sensor(s) (e.g., a motion sensor, a light sensor, a proximity sensor, etc.), or a combination thereof. Optional devices 372 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips.

Note that while FIG. 4 illustrates various components of a data processing system, it is not intended to represent any particular architecture or manner of interconnecting the components; as such details are not germane to embodiments of the present disclosure. It should also be appreciated that network computers, handheld computers, mobile phones, and other data processing systems, which have fewer components or perhaps more components, may also be used with embodiments disclosed hereinabove.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The techniques shown in the figures can be implemented using code and data stored and executed on one or more electronic devices. Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals).

The processes or methods depicted in the preceding figures may be performed by processing logic that comprises hardware (e.g., circuitry, dedicated logic, etc.), firmware, software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

While the filter washing system and methods have been described in terms of particular variations and illustrative figures, those of ordinary skill in the art will recognize that the filter washing system is not limited to the variations or figures described. In addition, where methods and steps described above indicate certain events occurring in certain order, those of ordinary skill in the art will recognize that the ordering of certain steps may be modified and that such modifications are in accordance with the variations of the filter washing system. Additionally, certain of the steps may be performed concurrently in a parallel process, when possible, as well as performed sequentially as described above. To the extent there are variations of the filter washing system, which are within the spirit of the disclosure or equivalent to the filter washing system found in the claims, it is the intent that this patent will cover those variations as well. Therefore, the present disclosure is to be understood as not limited by the specific embodiments described herein, but only by scope of the appended claims.

What is claimed is:

1. A system for cleaning and drying reusable air filters, comprising:
an exterior housing having an entrance for receiving one or more air filters;
a conveyor for moving the one or more air filters through the exterior housing;
a series of stations disposed along the conveyor for cleaning and drying the one or more air filters; and
an exit of the exterior housing for discharging the one or more air filters.

2. The system of claim 1, wherein the series of stations comprises any one or more of a pre-wetting station, an ultrasonic cleaning station, a rinsing station, and a drying station.

3. The system of claim 2, wherein the pre-wetting station is configured to wet the one or more air filters.

4. The system of claim 3, wherein the pre-wetting station is configured to apply a suitable cleaning solution to the one or more air filters.

5. The system of claim 4, wherein the pre-wetting station is configured to wet both sides of each of the one or more air filters.

6. The system of claim 5, wherein the pre-wetting station is configured to apply the cleaning solution to a dirty side of each of the one or more air filters.

7. The system of claim 2, wherein the ultrasonic cleaning station is configured to submerge each of the one or more air filters in a suitable cleaning solution.

8. The system of claim 7, wherein the ultrasonic cleaning station is configured to apply ultrasonic vibrations to each of the one or more air filters to loosen contaminants and debris that may be entrapped in the one or more air filters.

9. The system of claim 8, wherein the ultrasonic vibrations range in frequency between about 25 kHz and about 170 kHz.

10. The system of claim 9, wherein the ultrasonic vibrations range in frequency may range between about 70 kHz and about 130 kHz.

11. The system of claim 10, wherein the ultrasonic vibrations range in frequency between about 35 kHz and about 68 kHz.

12. The system of claim 11, wherein the ultrasonic vibrations have a frequency of about 40 kHz.

13. The system of claim 2, wherein the rinsing station is configured to use cleaning water to flush contaminants, debris, and the cleaning solution from each of the one or more air filters exiting the ultrasonic cleaning station.

14. The system of claim 13, wherein the rinsing station includes a piping system that includes water nozzles configured to spray water onto the one or more air filters.

15. The system of claim 2, wherein the drying station is configured to dry the one or more air filters exiting the rinsing station.

16. The system of claim 15, wherein the drying station includes one or more blowers configured to direct an airstream onto each of the one or more air filters.

17. The system of claim 16, wherein the drying station is configured to spin each of the one or more air filters to throw off water the one or more air filters.

18. The system of claim 17, wherein the drying station is configured to agitate each of the one or more air filters to throw off water the one or more air filters.

19. A method for forming a system for cleaning and drying reusable air filters, comprising:
forming an exterior housing having an entrance for receiving one or more air filters;
configuring a conveyor for moving the one or more air filters through the exterior housing;
arranging a series of stations along the conveyor for cleaning and drying the one or more air filters; and
forming an exit of the exterior housing for discharging the one or more air filters.

20. The method of claim 19, wherein arranging the series of stations comprises including any one or more of a pre-wetting station, an ultrasonic cleaning station, a rinsing station, and a drying station.
